(19) United States
(12) Patent Application Publication
(10) Pub. No.: US 2009/0043625 A1
(43) Pub. Date: Feb. 12, 2009

(54) Process Management System and Method

(76) Inventor: Hsiao Tung Yao, Singapore (SG)

Correspondence Address: TIPS GROUP;c/o Intellevate LLC, P. O. BOX 52050, Minneapolis, MN, 52050, US

(21) Appl. No.: 12/121,681

(22) Filed: May 15, 2008

(30) Foreign Application Priority Data
Aug. 8, 2007 (SG) 2007058457-2

(51) Int. Cl. G06Q 10/00

(52) U.S. Cl. 705/7

(57) ABSTRACT

The present invention relates to process management and control, such as a P&L forecast, budgeting and management system using data collection and computation to produce optimized P&L estimates. The production parameters and cost structure are collated and processed with a dedicated algorithm to simulate the sales forecast and cost factors of the required materials, the required machine hours, and the required labor hours to calculate profitability. The process produces indicators to easily examine the root causes of each project's areas of potential improvement. This present invention provides an application and tool for an effective management of a process.

### FIELD OF THE INVENTION

The present invention relates to a process management system and method. The invention will be described in the context of a P&L forecast and budgeting system and a method of data collection and computation to produce optimized estimates of P&L situations and process management and control indicators.

### BACKGROUND OF THE INVENTION

Recently, the P&L management and review has become a mechanism for executives to monitor and follow up the business operational results versus the AOP (Annual Operation Plan) and budgeting execution. Therefore, a highly effective P&L Management System is required to simulate the business situation and provide management information for critical decision and business management.

In conventional P&L management, the P&L reporting format is mainly based on the Finance P&L chart of account structure. Basically, the P&L review and management are only focussed on figures and the percentage of correlated figures but there is no effective way to verify the accuracy of figures and their implications.

For example, when the sales figures are increasing, the requirements for materials, labor and machinery, and the fixed cost and variable costs may change.

In the above described conventional method, only lump sum consolidated figures will be provided, but there are no detailed scientific measurements, rules, parameters and calculable algorithms used for a thorough computation to generate an effective P&L forecast and budgeting.

Therefore, the P&L data preparation, review and management may not really reflect the operational problems, and executive management team are not able to address the business situation accurately and on a timely basis. Additionally, the conventional P&L methods are not able to predict the required operational resources and fully utilize a flexible resource allocation to achieve lean management.

### SUMMARY OF THE INVENTION

The present invention aims at solving one or more of the above described problems. The invention can provide a Management System and method for easily and accurately realizing a business forecast and budgeting simulation. The system can be in the form of a P&L Management System.

The present invention provides a process analysis and control tool which collates primary process data from a plurality of sources, such as databases and knowledge management systems, relating to an operation, such as a manufacturing operation, and processes the primary data to derive secondary data indicative of measurements of the operation. The secondary data is used to analyse the operation, to predict outcomes of the operation, or to improve the operation.

In one embodiment uniquely designed template formats can be used to collect data from operations and to formulate the data with unique algorithms, rules and parameters.

According to an embodiment of the invention, one purpose of present invention can be attained by providing a process Management System including: (1) sales revenue, net value-added (NVA) and profit forecast; (2) cost structure simulation; (3) material, labor and machine budgeting by using specific algorithms and parameters; (4) analysis by dedicated process indicators for identifying business or production improvement areas.

The process can indicate the profit and loss by manufactured part, by production process, by project in each plant. It can define manufacturing benchmarks by comparing and analyzing production process, customer and plant by different matrix and dimensions.

A P&L Management System embodying the invention can include the following major functional modules: (1) Master Data Module (2) Part Information Module (3) Sales Information Module (4) Material Information Module (5) Engineering Information Module (6) Cost Structure Module (7) Reporting Module (8) Analysis Module. Using the above structured system modules, the P&L Management System can generate business information for project quotation and P&L forecast; and then when the actual business P&L is produced by the Accounting module of the Enterprise Resource Planning (ERP) system, the important parameters from actual P&L results can be factored into the systems to simulate the future P&L forecast more closely to the actual situation.

With the above described configuration and mechanism, the system modules hold 3 sets of parameters for the respective purpose of quotation, forecast P&L and actual P&L stages but the system modules can use the same algorithm for the simulation of computation. By comparing and analyzing the causes and effects of those parameters, the system can detect problem and support operation management to take quick and appropriate actions to resolve problem or make improvement.

The present invention provides a tool to manage operations such as molding, spray painting and assembly production process through proper quotation simulation to profitably quote customers; accurate forecast to effectively budget materials, labors and machines; intelligent analysis to productively improve business operation. The information used in preparing a quote can include information such as:
the size of the mold,
the shot weight,
the required machines,
machine hours,
the cycle time for each machine,
the labor for each machine,
the process sequence,
downtime and maintenance cycles for each machine,
material unit cost,
machine hourly rate,
labor hourly rate,
sales volume,
individual process yields,
overall process yield,
selling price.

The machine layout and interconnecting conveyors may be adjustable, and this is also optimized as part of the machine requirements and machine hours analysis.

According to an embodiment of the invention, there is provided a method of estimating, managing, forecasting or controlling a process including one or more operations requiring one or more inputs to produce a specified outcome, using a software architecture including:
a master data module and a plurality of subordinate modules, each module including corresponding data, or corresponding software, or both;
the subordinate modules being linked by identification information;
the method including the steps of:
calculating an output quantity;
calculating revenue using a revenue formula;
calculating the amount of material required;
calculating a cost of material using a material cost formula;
calculating an NVA using an NVA formula;
determining the machines required;
calculating machine hours required;
calculating machine cost using a machine cost formula;
calculating labor hours required;
calculating a labor cost using a labor cost formula;
calculating profit using a profit formula.

The subordinate modules can include:
a Part Information Module linking all master transaction data;
a Sales Information Module including first intermediate process using sales volume and sales price;
a Material Information Module comprising material price to obtain material cost;
an Engineering Information Module comprising of production yield rate, material usage, the labor usage and machine usage for formulating the computation of required materials, required labor and required machines;
a Cost Structure Module comprising computation of labor cost by obtaining the labor hourly rate and multiplying it with required labor and computation of plant overhead cost by obtaining machine hourly rate and multiplying it with required machine hours;
a Reporting Module generating the required management reports; and
an Analysis Module providing indicator of each project to detect project problems.

The method can include the steps of:
analysing the process by comparing actual process parameters with calculated parameters to identify out-of-specification results.

The step of analysing can include determining one or more progressive estimated values for one or more of the process parameters; and
monitoring actual values for one or more process indicators against the
corresponding estimated value of the corresponding process indicators.

The monitored parameters can be selected from labor hours, labor cost, machine hours, machine cost, material use, material cost, NVA, profit.

The method can include the step of using the results of the analysis to indicate whether one or more of the process operations requires adjustment.

The material cost formula is ($MAT=MATERIAL USED*UNIT PRICE), where $MAT is material cost. The revenue formula is (REVENUE=SALES*SALES PRICE). The NVA formula is NVA=REVENUE−$MAT. The machine cost formula is ($M/C=M/C HRS*M/C HRLY RATE), where $M/C is machine cost. The labor cost formula is ($LAB=LAB HRS*LAB HRLY RATE), where $LAB is labor cost. The profit formula is (PROFIT=NVA−$MC−$LAB).

The invention further provides a method of estimating, managing, forecasting or controlling a process, including the steps of:
specifying the process;
collating the process inputs information and parameters;
calculating the amount of material required;
calculating material cost;
calculating machine hours;
calculating machine cost;
calculating labor hours;
calculating labor cost;
calculating NVA;
calculating profit.

The method can include analysing one or more of the calculated values for NVA, profit, labor hours, labor cost, machine hours, machine cost, material used, material cost, against estimated values, and determining if any of the calculated values are out-of specification, and using the results of the analysis to identify whether a corresponding section of the process needs to be adjusted.

In a further embodiment, the invention provides a process management system, the process having one or more operational stages having one or more inputs and one or more outputs for producing a product, the system including:
a Master Data Module generating a plurality of master transaction data;
a Part Information Module linking all master transaction data;
a Sales Information Module generating an intermediate process using sales volume and sales price;
a Material Information Module comprising material price to obtain material cost;
an Engineering Information Module comprising of production yield rate, material usage, the labor usage and machine usage for formulating the computation of required materials, required labors and required machines;
a Cost Structure Module comprising computation of labor cost by obtaining the labor hourly rate and multiplying it with required labors and computation of plant overhead cost by obtaining machine hourly rate and multiplying it with required machine hours;
a Reporting Module generating the required management reports; and
an Analysis Module providing indicator of each project to detect project problems.

The Master Data Module can include customer master data, project master data, material master data, price information, cost structure master data of labor hourly rate and machine hourly rate.

The Part Information Module can include customer, project, customer part number and internal used part number, part description, and part's parents finished goods information.

The sales volume is multiplied with the sales price in the Sales Information Module to obtain sales revenue.

The indicator in the Analysis Module can include project profitability by NVA viewpoint; resource occupation percentage and resource occupation vs. NVA generation ratio.

The invention also provides production management arrangement including a factory having one or more machines, and machine monitoring means connected to a process management system, where the process having one or more operational stages having one or more inputs and one or more outputs for producing a product, the system including:
a Master Data Module generating a plurality of master transaction data;
a Part Information Module linking all master transaction data;
a Sales Information Module generating an intermediate process using sales volume and sales price;
a Material Information Module comprising material price to obtain material cost;
an Engineering Information Module comprising of production yield rate, material usage, the labor usage and machine usage for formulating the computation of required materials, required labors and required machines;
a Cost Structure Module comprising computation of labor cost by obtaining the labor hourly rate and multiplying it with required labors and computation of plant overhead cost by obtaining machine hourly rate and multiplying it with required machine hours;
a Reporting Module generating the required management reports; and
an Analysis Module providing indicator of each project to detect project problems, whereby actual process indicators are compared with expected process indicators.

The process can be adjusted on the basis of the analysis of the process indicators.

Machines performing different tasks will usually have different cycle times, so slower machines can be duplicated, or the faster machines can complete their production run, and their outputs can be queued for the slower machines, where the slower machines are at the output end, and the faster machines are then available to be assigned to other tasks while the slower machines complete the initial production run. Similarly, where the slower machines are at the input end of the process, the output of the slower machines can be stockpiled until there are sufficient to justify the use of the faster machines.

### BRIEF DESCRIPTION OF THE DRAWINGS

FIG. 1 shows the system functional modules and its correlated structure according to the present invention.

FIG. 2 shows the data collection flow and data structure.

FIG. 3 shows the system structure overview and its data type from respective stage of quotation, forecast P&L and actual P&L.

FIG. 4 shows the information flow which converts from quotation stage to forecast stage, and then factors in the actual P&L from ERP system to reflect the actual stage and future forecast simulation.

FIG. 5 shows the basic P&L reporting format in the system.

FIG. 6 shows the indicators from the P&L reporting in the system.

FIG. 7 illustrates typical functional blocks found in a computer.

FIG. 8 illustrates a computer network.

FIG. 9 illustrates a master data module adapted for use in an embodiment of the invention.

FIG. 10 illustrates a part information module adapted for use in an embodiment of the invention.

FIG. 11 illustrates a sales information module adapted for use in an embodiment of the invention.

FIG. 12 illustrates a material information module adapted for use in an embodiment of the invention.

FIG. 13 illustrates an engineering module adapted for use in an embodiment of the invention.

FIG. 14 illustrates a cost structure module adapted for use in an embodiment of the invention.

FIG. 15 illustrates a reporting module adapted for use in an embodiment of the invention.

FIG. 16 illustrates an analysis module adapted for use in an embodiment of the invention.

FIGS. 17A & 17B form an interaction diagram used to illustrate a process according to an embodiment of the invention.

FIG. 18 shows an illustrative factory layout.

FIG. 19 is a flow diagram illustrating the implementation of an embodiment of the invention.

The item numbering system used to identify elements in the drawings has the figure number as the first or first and second digits as required, while the second last and last digits indicate the specific element in the figure.

### DESCRIPTION OF THE PREFERRED EMBODIMENT

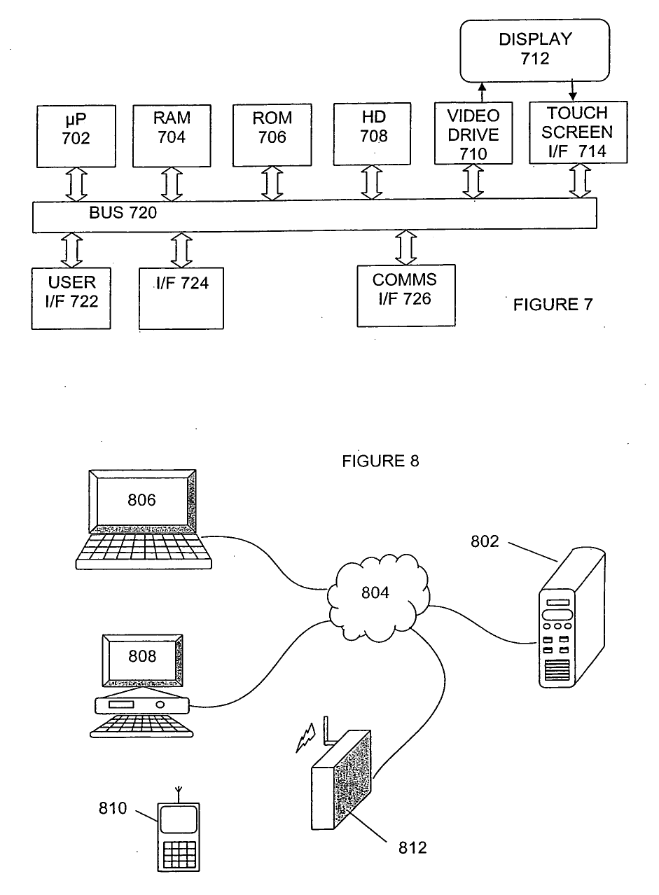

The context of an embodiment of the invention is illustrated in FIGS. 7, 8, 18, and these drawings are not to be taken as limiting the scope of the application of the process of the inventive method.

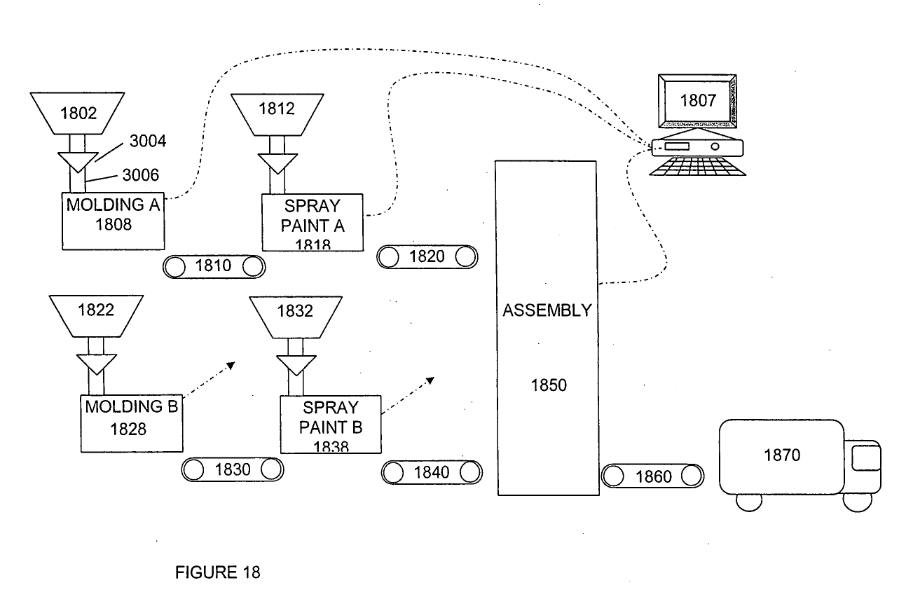

FIG. 18 is illustrative of a factory for molding, painting, and assembling components. In FIG. 18 two components, A & B are molded, spray painted and assembled. Part A is molded in first molding station including a material hopper 1802, connected by duct 1806 to molding machine 1808. A shot controller 1804 controls the amount of material for each cycle. A conveyor to 1810 conveys the product from the molding machine 1808 to a spray painting station 1830 which is fed from paint reservoir 1812. Part B follows a similar path through molding machine 1828, conveyor 1830, and spray paint station 1838.

Part A is carried by conveyor 1820 to assembly station 1850, and part B is carried by conveyor 1840 to assembly station 1850. A further conveyor 1860 carries the assembled parts to a store or distribution point for onward dispatch. The various stages and processes are monitored by computer 1807 which is connected into a local area network. Such an arrangement can enable the quasi-real time collection of actual data.

FIG. 7 is a simplified schematic functional block diagram illustrating functional components of a computer which can be used in implementing the invention. The actual composition, arrangement, and interconnexion of the functional blocks may be different in practice. A processor 702 communicates with a number of functional elements, as shown schematically by the bus 720. The computer can include RAM 704, ROM 706, hard drive 708, display driver 710, screen 712, user interface 722, device interfaces 724 and communication interface. One or more interface devices such as keyboard, mouse, voice recognition device, etc can be connected to the user interfaces such as 722. Similarly, one or more peripheral devices, such as printers, etc., can be connected to the computer via device interfaces such as 724. Modems, wireless modems and other communication interfaces can be connected via communications interfaces 726. Optionally, a touch screen interface 714 can also be provided to enable the user to enter instructions etc. The computer can be programmed in a known manner using the parameters and algorithms of the invention and operated to control, estimate, or manage a process.

FIG. 8 illustrates a computer network which can be used in implementing the process. A number of computers, such as laptop 806, desktop 808, hand held wireless computer 810 and associated wireless modem or base station 812 can be linked into a communication network 804. The network can be a local area network (LAN) or a wide area network (WAN) such as an IP network on which a Virtual Private Network (VPN) is implemented. The computers of the company can have secure access to the VPN. The computers can be located in different departments of a company, such as sales, production, engineering, finance, etc. The computers 806, 808, 810 can connect to a central computer or server 802 were the information from each department relating to a project can be collated and processed. For example, the Sales Department may be represented by handheld computer 810, and the sales personnel can enter contract information when a contract is awarded, as discussed more fully below. Other computers can be available to product and factory managers, engineers and company executives to contribute to tender preparation, or monitor the actual performance etc.

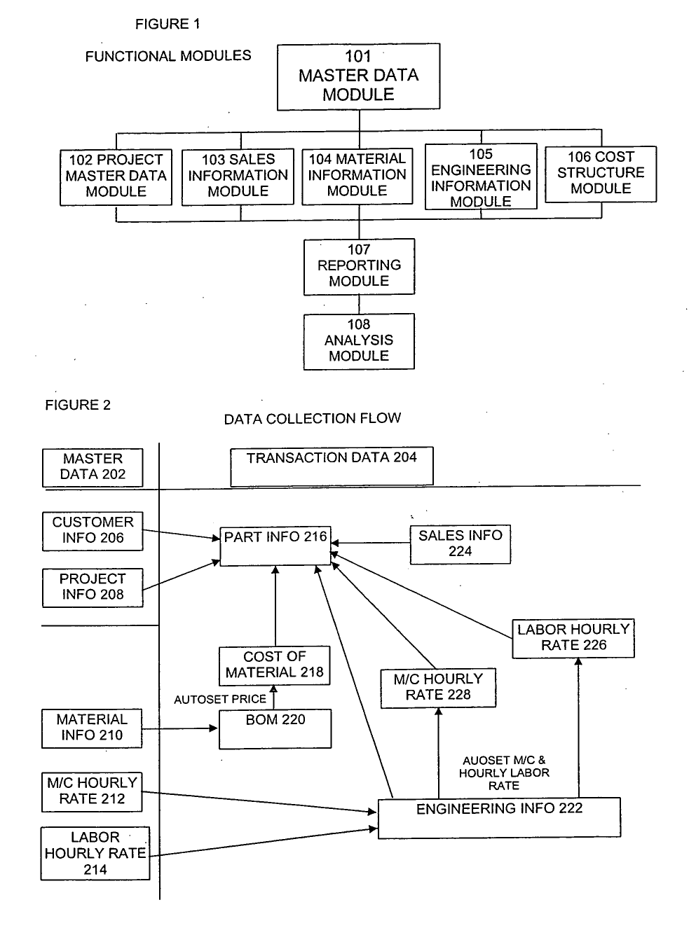

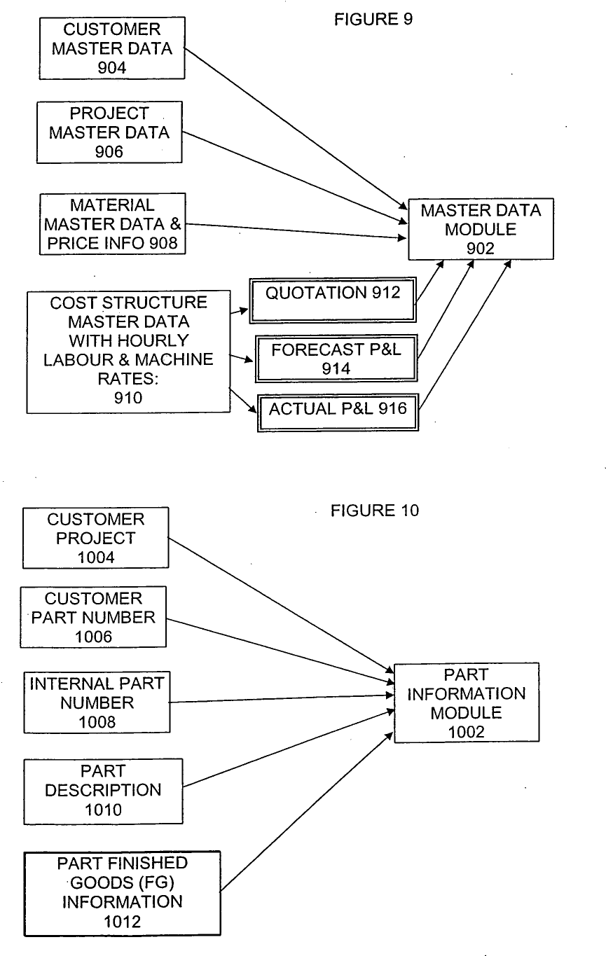

FIG. 1 shows the system functional modules and correlated structure according to an embodiment of the present invention. The functional module “Master Data Module 101” is shown at FIG. 2 and FIG. 9, and includes the customer master data 206, 904, project master data 208, 906, material master data and its price information 210, 908, cost structure master data of labor hourly rate 214, 910 and machine hourly rate 212, 910. The cost structure master data are classified for respective purpose of quotation 912, forecast P&L 914 and actual P&L 916 stages.

As illustrated in FIG. 10, the functional module “102. Part Information Module” includes customer project information 1004, customer part number (P/N) 1006 and internal part number (SAP#) 1008, part description 1010 and the part's parents finished goods (FG) information 1012. The part information provides a key to link up all the other related transaction data to form the forecast P&L simulation. All the parts incurring sales revenue in each month can have an entry by month in this module.

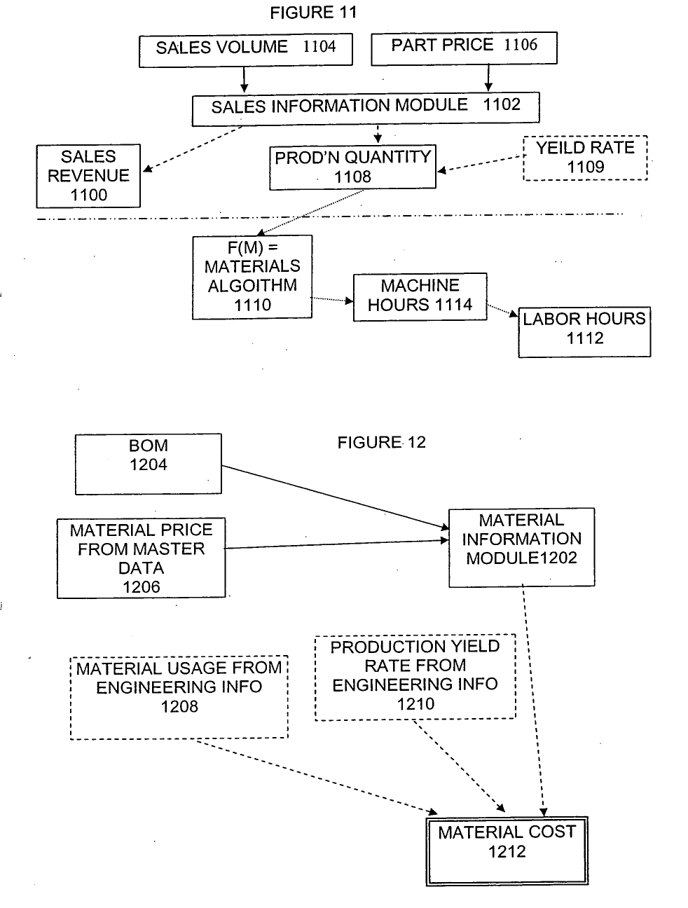

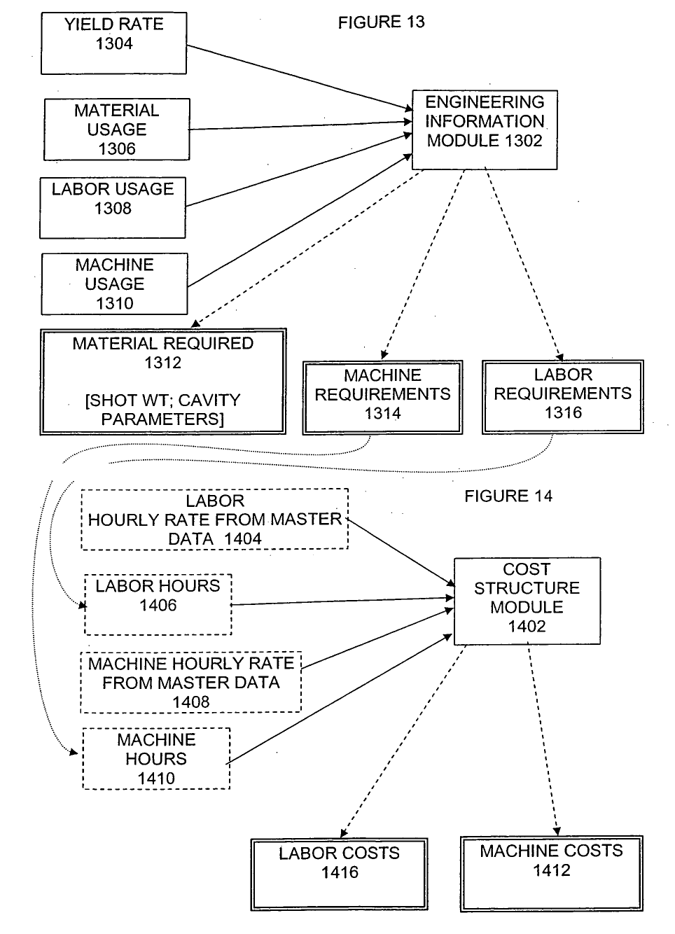

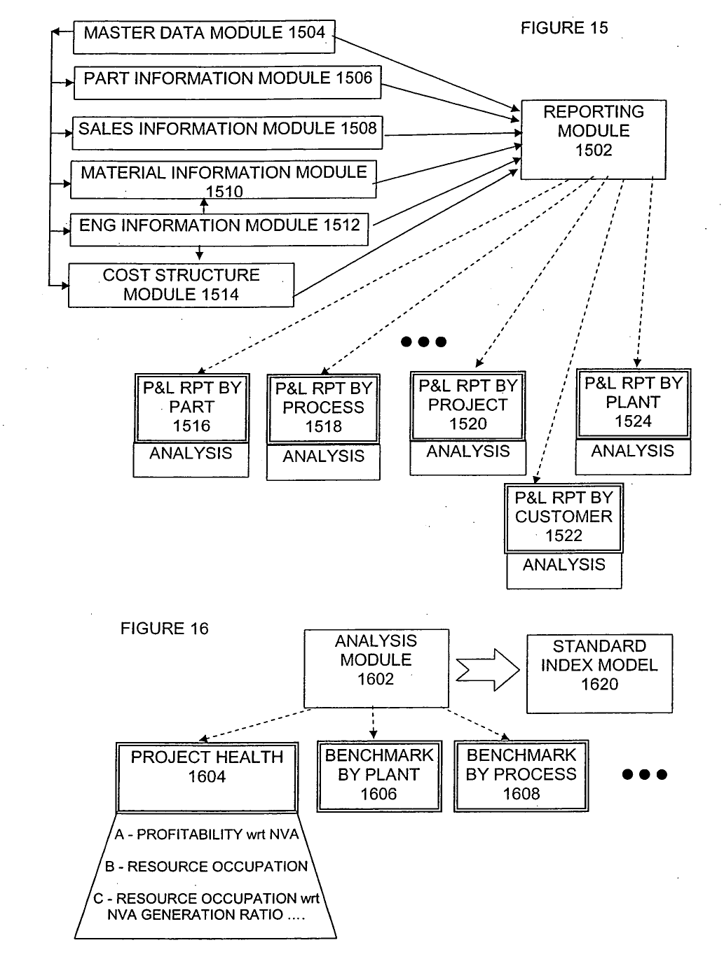

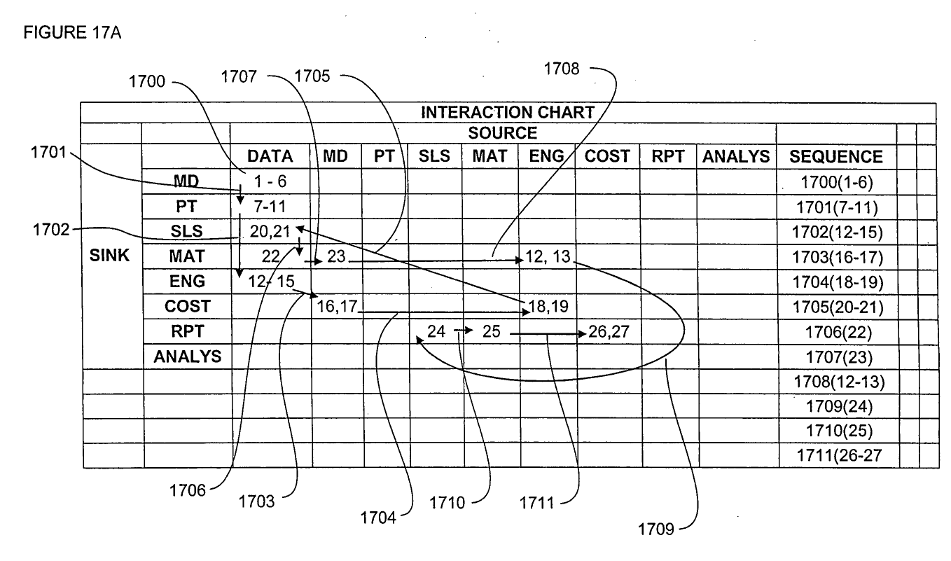

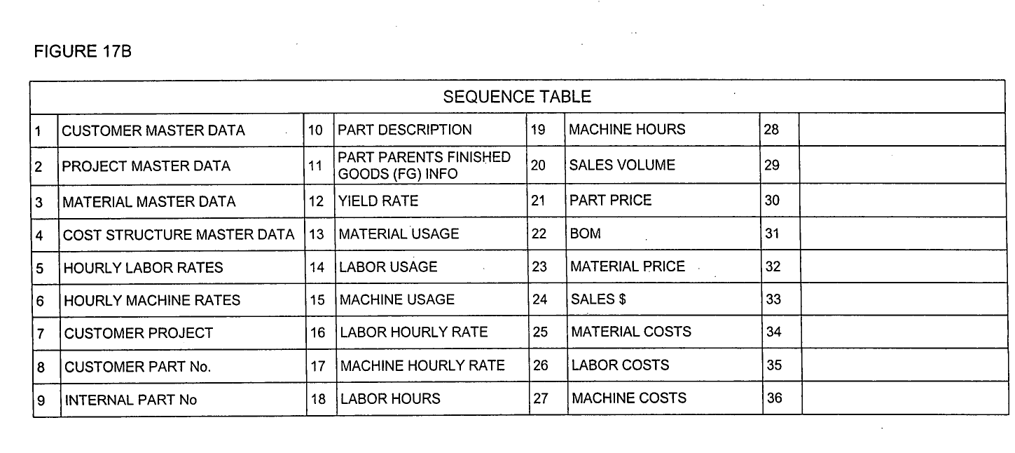

The functional module “Sales Information Module 103” in FIG. 1 includes the sales volume and sales price for the part. FIG. 11 shows the inputs and outputs of the Sales Information Module, including inputs Sales Volume 1104, and Part Price 1106. Using Eq10, the sales volume is multiplied by sales price to generate the sales revenue 1100, also shown in FIG. 11. As indicated below the dash-double dot line, the sales volume is an important parameter for: (a) the computation of produced quantities 1108 with production yield rate 1109 taken into consideration; (b) the computation of required materials using a specific algorithm and other parameters, 1110; (c) the computation of required labor using a specific algorithm and other parameters, 1112; (d) the computation of required machine capacity using a specific algorithm and other parameters, 1114. This enables the fundamental budgeting information for materials, labor and machines to be generated.

The functional module “Material Information Module 104” in FIGS. 1 & 12 includes the Bill of Material (BOM) of the part 1204, and gets the material price 1206 from the master data. By considering the production yield rate 1210 and material usage 1208 for producing the part, this module can formulate the data with unique algorithms, rules and parameters to obtain the material cost 1212.

The module “Engineering Information Module 105” in FIGS. 1 & 13 includes the production yield rate 1304, the material usage 1306, the labor usage 1308 and machine usage 1310 for producing the part. All those engineering parameters are used to formulate the computation of required materials 1312, required labor 1316, and required machine capacity 1314. The unique computation for material requirement is used in molding production process including the shot weight, number of cavity parameters. The unique computation for labor and machine requirement is used in molding production process including the cycle time, UP (Utilization*Productivity) factors.

“Cost Structure Module 106” shown in FIGS. 1 & 14 includes (a) computation of labor cost 1416 by obtaining the labor hourly rate 1404 from the master data and multiplies required labor 1406 from the Engineering Information Module 1302; (b) computation of plant overhead cost 1412 by obtaining the machine hourly rate 1408 from the master data and multiply required machine hours 1410 from the Engineering information Module.

“Reporting Module 107” 1502 is adapted to flexibly generate the required management reports for instances the P&L report by part, by process, by project, by customer, by plant, and etc. It enables management to have a full picture of the plant P&L forecast and to easily drill down to the detail level to zoom in on any problem, thus facilitating continuous improvement.

“Analysis Module 108” 1602 provides (a) the effective indicator the healthy condition of each project 1604 and its impact toward P&L results; (b) the benchmark comparison by plant 1606, by process 1608, by customer and etc. The indicators consist of (a) project profitability by NVA viewpoint; (b) resource occupation percentage; (c) resource occupation vs. NVA generation ratio and etc. Through this module, it can build a standard index model 1620 to quickly display and detect the project problems.

FIG. 2 shows data collection flow and data structure of a system according to an embodiment of the invention. The system has the basic Master Data 202 including Customer Master 206, Project Master 208, Material Master 210 and Hourly Rates of Cost Structure 212, 214. The process for tendering for a project can use similar inputs for the generation of a quote to the inputs for a process of forecasting the project outcomes or the process of project management. When plant is allocated by customer's project, the detail allocated part information of this project will be collected and put into the system. In a project, there can be many parts which are produced by different processes, for instance, molding process, spray painting process, pad printing process, assembly process, and etc. The data collection flow enables all part related information in the production to be systematically collected by different departments in an organization to build the forecast model.

With reference to the data collection flow, the data collection order occurs in the following stages:
A Part Info 216 consists of the customer name, project name, customer part number, internal part number and description, the correlated finished goods for this part, and etc. to ensure the part information can be consolidated by finished goods, by project, by customer to compute the sales revenue and production cost.
B After Part Info 216 is established, we can start to collect Sales Info 224 and BOM 220 Info at the same time. Sales Info 224 includes the sales price and sales volume of the part. BOM info 220 consists of the materials used for the part, sub-con cost, and other handling cost.
C Because the Material Master data is established, the material price can be obtained when the BOM Info 220 generates the Cost of Material Info 218 automatically.
D The collection of Engineering Info 222 starts when the BOM info 220 is available. Engineering Info 222 includes the machine specification, cycle time, yield rate, material usage, and etc. info for producing the part. Most of the computation algorithms in the system use parameters from the engineering information. The production shop floor can collect the engineering information on a regular basis, such as hourly or daily, and get the best estimation for the forecast of required materials, labors, and machines.
E When the required machine and labor information are complete in the Engineering Info 222, the system will automatically retrieve the related cost structure data, Machine Hourly Rate 228 and Labor Hourly Rate 226 from the master data.

In the above described data collection flow for each part, the system is ready to do the forecast simulation for the specific part. But this is not enough for a whole picture of a plant operation without collecting all the parts produced and sold in the plant. From all Part Info 216 plus Sales Info 224, the forecast sales revenue can be generated. From the BOM Info 220, Cost of Material Info 218 and Engineering Info 222, the system can compute the material cost, other material handling cost, required machine hours and labor hours for the parts. Accordingly, the system can generate the forecast P&L report according to those cost factors.

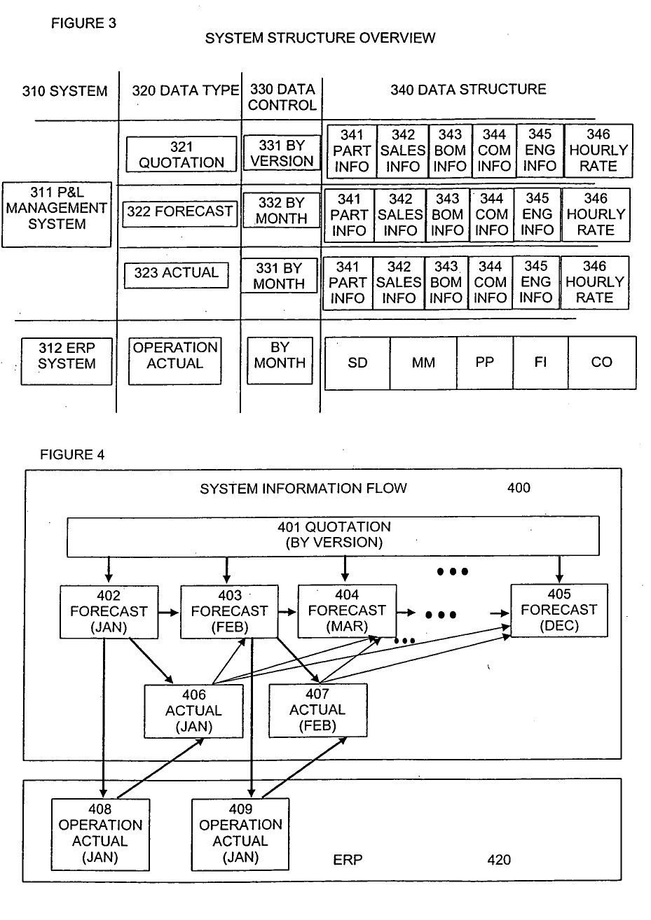

FIG. 3 shows the system structure overview and its data type from respective stage of quotation, forecast P&L and actual P&L. “System 310” consists of the P&L Management System 311 and the legacy ERP 312 (Enterprise Resource Planning) system. P&L Management System 311 can be an enhanced version of the legacy ERP System 312. The P&L Management System 311 is based on to sales forecast and the production parameters to simulate the actual production situation and come up the P&L forecast and budgeting. The legacy ERP System 312 is based on the actual production situation to collect the production parameters which are integrated with P&L Management System 311 to make the simulation more accurate for the coming months and similar projects. P&L Management System 311 consists 3 kinds of Data Type 320 for each project stages which are Quotation stage 321, Forecast stage 322, and Actual stage 323. Quotation stage 321 is the beginning of the. Data Type 320. When customers make a request for quotation (RFQ), Sales can input all thee required data (as it shows in the Data Structure 340) into the system to get the quotation simulation. When customers change the RFQ spec, Sales can adjust the data to make simulation accordingly and store the quotation by version. The Quotation stage is managed in the system by By Version 331 of the Data Control 330. After customers are satisfied the quotation and projects are awarded. Customers will provide the sales forecast for the production. The basic information in the Quotation stage 321 will be used in the Forecast stage 322 as the initial data (as it shows in the Data Structure 340). Then, the monthly sales forecast volume will be maintained in the system and the production parameters are updated by the actual production cycle. The Forecast stage 322 can generate the P&L forecast the budget by month. The Forecast stage 322 is managed in the system by By Month 331 of the Data Control 330. The Actual stage 323 is based on some actual production parameters and cost factors of the legacy ERP System 312 to update the required data as it shows in the Data Structure 340. By comparing the Actual 323 result of the P&L Management System 311 and the actual result of ERP System 312, it can examine the accuracy of the P&L Management System and adjust the parameters accordingly to improve the accuracy of the simulation model to more accurately reflect the future P&L forecast and budget. Data Structure 340 is the detail data contents as it shows in the FIG. 2 Data Collection Flow. The computerized system structurally stores the data in the system data base for the computation and reporting. Data Structure mainly consists of the Part Info 341, Sales Info 342, BOM (bill of material) Info 343, COM (cost of material) Info 344, Engng (Engineering) Info 345, and Hourly Rate 346 (cost structure of machine and labor). The Part Info 341 is the main key for each transaction. All the other information is supporting data to the part for the computation algorithm of P&L forecast report and budgeting.

FIG. 4 shows the information flow which converts from quotation stage to forecast stage, and then factors in the actual P&L from ERP system to reflect the actual stage and future forecast simulation. As described earlier, the Quotation 401 is maintained by version. The last version is taken to be the agreed version by customers. Then the Sales will get the volume forecast information of the project life cycle from customers to put into the Forecast 402 by month to do the revenue simulation. It depends on when the project is started to generate revenue and when the project is end of life. The initial basic data can be copied from the Quotation stage 401 to Forecast stage 402 on its corresponding months (it takes from Jan as an example in the diagram). During the project life cycle, the quotation price could be changed. The new version of quotation will be updated in the Quotation stage 401 and also maintained in the Forecast stage 402. When the projects are under the actual production, the ERP system can collect all the actual production parameters and the actual cost structure from the operation. The Operation Actual 408 will be used to update the Actual stage 406 by combining the Forecast data 402. And, from the learning of Operation Actual 408, those production parameters and cost structure will be factored into the future forecast accordingly to make the future P&L forecast and budgeting more accurate (as shows on the Forecast 403 and its upward months). The System Information Flow repeats month by month to form the P&L Forecast reporting and budgeting of the P&L Management System.

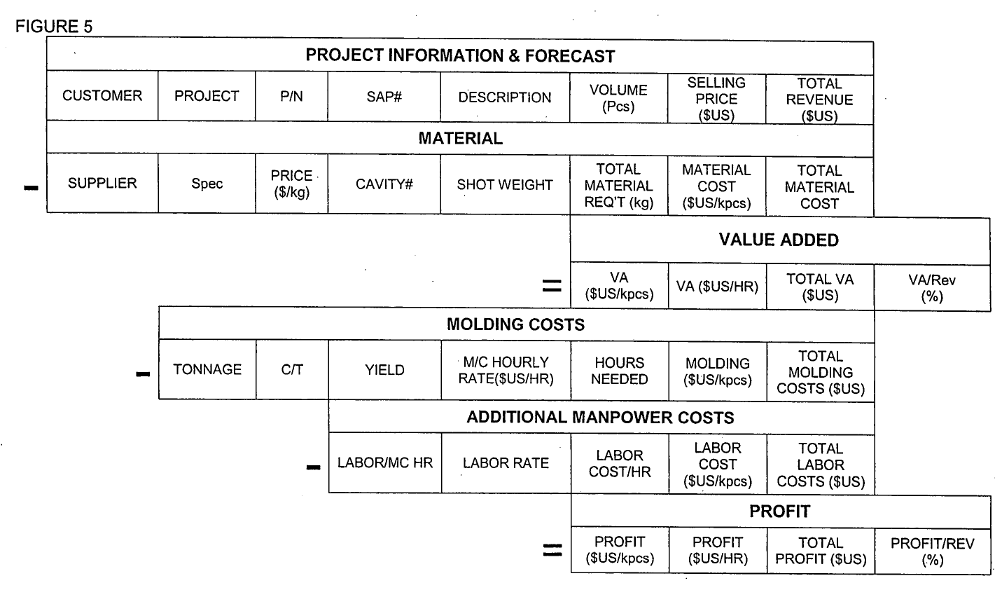

FIG. 5 shows the basic P&L reporting format in an embodiment of the system. This is a summary of the data collection from the FIG. 2. The report consists of Revenue, Material Cost Value-added, Overhead Cost (Machine Cost), Labor Cost and Profits. With the unique algorithm in the report, the system can get the required materials, machine occupied hours, and required labor hours for budgeting. By using the machine hourly rate and labor hourly rate of the plant cost structure, the P&L report can display the profitability by part, by project, and by customer.

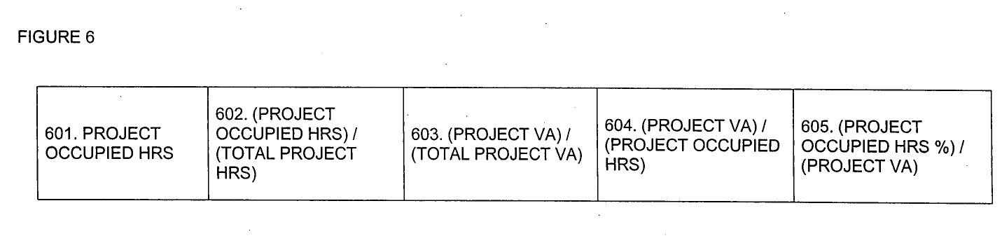

FIG. 6 shows the indicators from the P&L reporting in the system. It consists of Project Occupied hrs 601 (Project Occupied Hrs)/(Total Project Hrs) 602 (Project VA)/(Total Project VA) 603 (Project VA)/(Project Occupied Hrs) 604 (Project Occupied Hrs %)/(Project VA %) 605 to easily analyze the project cost, resource use, and profitability. Project Occupied Hrs 601 is calculated by the algorithm of production parameters. It shows the required machine utilization. It is useful for the machine hour budgeting and also the cost computation base. (Project Occupied Hrs)/(Total Project Hrs) 602 shows each project's occupation percentage of total project used capacity. A bigger ratio means a bigger resource usage by this project. (Project VA)/(Total Project VA) 603 is to show each project's VA (value-added) generation percentage of total project generated VA. A bigger ratio means a bigger VA generated by this project. (Project VA)/(Project Occupied Hrs)) 604 shows the project machine hourly rate. It is an indicator to compare with the machine hourly rate from the plant cost structure. The higher machine hourly rate of this indicator means the loss from the plant cost structure and it needs to look into the price and productivity of this project for improvement. (Project Occupied Hrs %)/(Project VA %) 605 shows the ratio of resource use for VA generation. The higher ratio means the project uses more resources but generate less VA. The ideal case for this ratio is close to “1” for a healthy project. All these above indicators facilitate quick examination of the root causes of any discrepancies in each project.

The following algorithms can be used in implementing an embodiment of the invention:

Produced volume=(Sales volume)/(roll-up yield) Eq01

Roll-up Yield=(Molding Process Yield)*(Spray Painting Yield)*(Assembly Yield)*(Other Yield) Eq02

Required Raw Material=(Produced volume)*(Shot weight)/(#of Cavity)*(1−Allowed Reground Material Rate) Eq03

Material Cost=(Required Raw Material)*(Unit Price) Eq04

UP Factor=(Machine Output Hours)/(Machine Occupied Hours) Eq05

Required Machine Hours=(Produced volume)*(Cycle Time)/3600*(#of Cavity)/(UP Factor) Eq06

Machine Cost=(Required Machine Hours)*(Machine Hourly Rate) Eq07

Required Labor Hours=(Required Machine Hours)*(Labor Per Machine) Eq08

Labor Cost=(Required Labor Hours)*(Labor Hourly Rate) Eq09

Revenue=(Sales volume)*(Selling Price) Eq10

NVA=(Revenue)−(Material Cost) Eq11

Profits=(NVA)−(Machine Cost)−(Labor Cost) Eq12

These formulae can use the following information:
Sales Volume
Molding Process Yield. This can be statistically determined. Variations can effect outcome, and thus can be used to indicate health of process.
Spray Painting Yield. This can be statistically determined. Variations can effect outcome, and thus can be used to indicate health of process.
Assembly Yield. This can be statistically determined. Variations can effect outcome, and thus can be used to indicate health of process.
Other yield. This can be statistically determined. Variations can effect outcome, and thus can be used to indicate health of process.
Cavity Size. This is fixed for a product.
Shot Weight. This is fixed for a cavity.
Allowed reground Material Weight. Usually fixed.
Unit Price (Raw Material). Fixed in batches.
Machine Hourly Rate. Fixed.
Cycle Time. Fixed, but can be affected by maintenance & break-down. Excess variation can be used to trigger process review.
Labor per Machine. The actual labor per machine may vary from the nominal value. Excess variation can be used to trigger process review.
Labor Hourly Rate. Fixed.
Selling Price

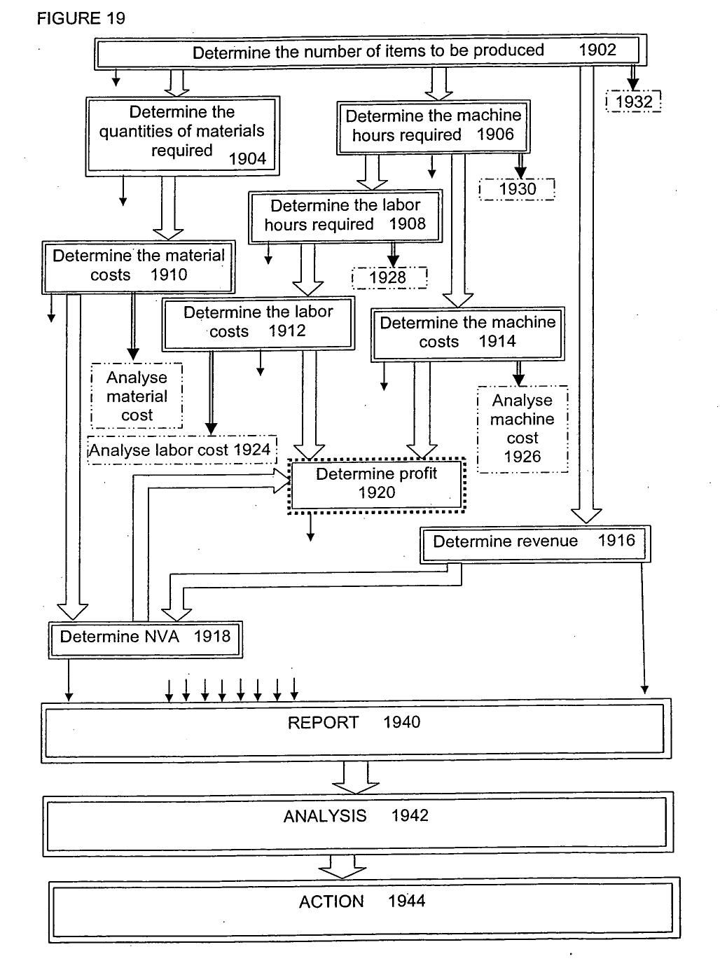

FIG. 19 is a flow diagram which illustrates the interrelation between the various process parameters, indicators, and algorithms. The architecture of the layout of FIG. 4 can be used as the basis for the quotation, forecast and actuals, and for cross-comparison analysis.

At stage 1902, the number of items to be produced is determined. This is done using Eq02 to calculate the Roll-up Yield as the product of the yields of the individual processes. Eq01 then calculates the Volume to be Produced by dividing the Sales Volume by the Roll-up Yield. From the Produced Volume calculation of step 1902, the amount of material required is determined at step 1904, and the machine hours are determined at step 1906, from which labor costs are derived at step 1908.

The Produced Volume from Eq01 (step 1902) is multiplied by the Shot Weight and divided by product of the Cavity Size and (1 minus the Allowed Reground Material Rate) to calculate the Required Raw Material in Eq03 at step 1904.

At step 1910, the Material Cost is calculated using Eq04 as the product of the Raw Material Required (Eq03) and the Unit Price for the Raw Material.

At step 1906, the machine hours required can be calculated. The UP Factor can be calculated using Eq05 by dividing the Machine Output Hours by Machine Occupied Hours. Required Machine Hours are then calculated using Eq06 by multiplying Produced volume (Eq01) by Cycle Time (seconds) and dividing by 3600 times the product of the Cavity Number and the UP Factor (Eq05). The Cycle Time is determined by such factors as materials, cavity size, temperatures needed for the particular molding step.

At step 1914, Machine Cost can be calculated using Eq07 as the product of Required Machine Hours (Eq06) and Machine Hourly Rate.

At step 1908, Required Labor Hours can be calculated using Eq08 as the product of Required Machine Hours (Eq06) and Labor Per Machine.

Step 1912 can be used to calculate Labor Cost using Eq09 as the product of Required Labor Hours (Eq08) and Labor Hourly Rate.

At step 1916, Revenue is calculated using Eq10 as the product of Sales Volume (also used in Eq01) and Selling Price.

At step 1918, NVA is calculated using Eq11 by subtracting Material Cost (Eq04, step 1910) from Revenue (Eq10, 1916).

At step 20, Profit is calculated using Eq12 by subtracting Machine Cost (Eq01, step 1914) and Labor Cost (Eq09, step 1912) from NVA (Eq11, step 1918).

A number of process control and management functions can also be integrated into the system, as illustrated at 1922 to 1932 in FIG. 19. These control points can be based on a comparison of actual performance against predicted performance.

At step 1922, the material cost can be monitored on a continuing basis during a production run. At a point in time, the number of parts produced and the number of parts within specification can be determined. If the parts within specification are less than that predicted by the nominal Roll-up Yield, this can be used as an indication of a problem with the process, and trigger an investigation as to the cause, eg, material quality or contamination, process temperature, process time, equipment fault, etc.

If step 1926 indicates that machine costs are greater than budgeted, or greater than the proportion of budget expected for the number of parts produced, the factors influencing machine costs can be investigated. Similarly, if step 1924 indicates that the labor costs at a point in time are greater than budgeted, factors influencing labor hours can be investigated.

Again, at step 1932, if the production falls behind schedule, this can trigger an investigation.

These analysis points facilitate early intervention where the process begins to run out of specification.

The information concerning the process is collated from all stages of the process at 1940 in the report, as indicated by the single line arrows. An analysis stage 1942 and an action stage 1944 are implemented to detect and adjust out-of-specification performance.

FIGS. 17A & 17B form an interaction chart illustrating the sequence of operations according to an embodiment of the invention. The chart has an upper row of modules DATA (INPUT), MD (MASTER DATA), PT (PROJECT MASTER DATA), SLS (SALES INFO), MAT (MATERIAL INFO), ENG (ENGINEERING INFO), COST (COST STRUCTURE), RPT (REPORT), ANALYS (ANALYSIS), which are the SOURCES of interactions with the correspondingly named modules on the left hand column (SINKS). The cell at the intersection between a source and a sink includes information concerning the interaction between the source and the sink. The arrows numbered 1701 to 1711 indicate the sequence of the interactions.

Initially, at 1700, data 1 to 6 from the sequence table (FIG. 17B) is input to the master data MD. Thus the customer master data, project master data, material master data, cost structure master data hourly labor rates, and hourly machine rates are entered at this stage.

At 1701, project data 7 to 11 from the Sequence Table is entered into the PT.

At 1702, engineering data 12 to 15 is entered into ENG.

At 1703, MD provides hourly labor rates 16, and hourly machine rates 17 to COSTS.

At 1704, ENG supplies labor hours 18 and machine hours 19 to COSTS.

At 1705, sales volume 20 and sales price 21 are supplied to SLS.

At 1706, the BOM 22 is provided to MAT.

At 1707, MD provides material price 23 to MAT.

At 1708, ENG provides yield rate 12 and material usage to MAT.

At 1709, SLS provides sales value 24 to RPT.

At 1710, MAT provides material cost 25 to RPT.

At 1711, COST provides labor cost 26 and machine cost 27 to RPT.

Reference in the specification to prior art techniques is not an admission by the applicant that that prior art is part of the common general knowledge in the field.

The use of the words “comprising”, “consisting of” and similar terms are to be understood as inclusive rather than exclusive, unless the exclusive interpretation is expressly stated or clearly implied.

While the invention has been described with reference to specific embodiments of features and functions, the invention can subsist in other combinations of such elements within the spirit of this disclosure.

1. A method of estimating, managing, forecasting or controlling a process including one or more operations requiring one or more inputs to produce a specified outcome, using a software architecture including:
a master data module and a plurality of subordinate modules, each module including corresponding data, or corresponding software, or both;
the subordinate modules being linked by identification information;
the method including the steps of:
calculating an output quantity;
calculating revenue using a revenue formula;
calculating the amount of material required;
calculating a cost of material using a material cost formula;
calculating an NVA using an NVA formula;
determining the machines required;
calculating machine hours required;
calculating machine cost using a machine cost formula;
calculating labor hours required;
calculating a labor cost using a labor cost formula;
calculating profit using a profit formula.

2. A method as claimed in claim 1, wherein the subordinate modules include:
a Part Information Module linking all master transaction data;
a Sales Information Module including first intermediate process using sales volume and sales price;
a Material Information Module comprising material price to obtain material cost;
an Engineering Information Module comprising of production yield rate, material usage, the labor usage and machine usage for formulating the computation of required materials, required labor and required machines;
a Cost Structure Module comprising computation of labor cost by obtaining the labor hourly rate and multiplying it with required labor and computation of plant overhead cost by obtaining machine hourly rate and multiplying it with required machine hours;
a Reporting Module generating the required management reports; and
an Analysis Module providing indicator of each project to detect project problems.

3. A method as claimed in claim 1 or claim 2, including the steps of: analysing the process by comparing actual process parameters with calculated parameters to identify out-of-specification results.

4. A method as claimed in claim 3, wherein the step of analysing includes
determining one or more progressive estimated values for one or more of the process parameters; and
monitoring actual values for one or more process indicators against the corresponding estimated value of the corresponding process indicators.

5. A method as claimed in claim 4, wherein the monitored parameters are selected from project occupied hours, project VA, labor hours, labor cost, machine hours, machine cost, material use, material cost, NVA, profit.

6. A method as claimed in any one of claims 3 to claim 5, including the step of using the results of the analysis to indicate whether one or more of the process operations requires adjustment.

7. A method as claimed in claim 1, wherein:
the material cost formula is ($MAT=MAT USED*UNIT PRICE);
the revenue formula is (REV=SALES*SALES PRICE);
the NVA formula is (NVA=REV−$MAT);
the machine cost formula is ($M/C=M/C HRS*M/C HRLY RATE);
the labor cost formula is ($LAB=LAB HRS*LAB HRLY RATE);
the profit formula is (PROFIT=NVA−$MC−$LAB).

8. A method of estimating, managing, forecasting or controlling a process, including the steps of:
specifying the process;
collating the process inputs information and parameters;
calculating the amount of material required;
calculating material cost;
calculating machine hours;
calculating machine cost;
calculating labor hours;
calculating labor cost;
calculating NVA;
calculating profit.

9. A method as claimed in claim 8, including analysing one or more of the calculated values for NVA, profit, labor hours, labor cost, machine hours, machine cost, material used, material cost, against estimated values, and determining if any of the calculated values are out-of specification, and using the results of the analysis to identify whether a corresponding section of the process needs to be adjusted.

10. A process management system, the process having one or more operational stages having one or more inputs and one or more outputs for producing a product, the system including:
a Master Data Module generating a plurality of master transaction data;
a Part Information Module linking all master transaction data;
a Sales Information Module generating an intermediate process using sales volume and sales price;
a Material Information Module comprising material price to obtain material cost;
an Engineering Information Module comprising of production yield rate,
material usage, the labor usage and machine usage for formulating the computation of required materials, required labors and required machines;
a Cost Structure Module comprising computation of labor cost by obtaining the labor hourly rate and multiplying it with required labors and computation of plant overhead cost by obtaining machine hourly rate and multiplying it with required machine hours;
a Reporting Module generating the required management reports; and
an Analysis Module providing indicator of each project to detect project problems.

11. A management system according to claim 10 wherein the Master Data Module comprises of customer master data, project master data, material master data, price information, cost structure master data of labor hourly rate and machine hourly rate.

12. A management system according to claim 10 wherein the Part Information Module comprises of customer, project, customer part number and internal used part number, part description, and part's parents finished goods information.

13. A management system according to claim 10 wherein the sales volume multiplies the sales price in the Sales Information Module to obtain sales revenue.

14. A management system according to claim 10 wherein the indicator in the Analysis Module comprises of project profitability by NVA viewpoint; resource occupation percentage and resource occupation vs. NVA generation ratio.

15. A production management arrangement including a factory having one or more machines, and machine monitoring means connected to a process management system as claimed in claim 10, whereby actual process indicators are compared with expected process indicators.
